(19) United States
(12) Patent Application Publication
(10) Pub. No.: US 2022/0107831 A1
(43) Pub. Date: Apr. 7, 2022

(54) DATA CENTER APPLICATION TROUBLESHOOTING

(71) Applicant: VMware, Inc., Palo Alto, CA (US)

(72) Inventor: RAHUL CHAWATHE, Bangalore (IN)

(21) Appl. No.: 17/240,989

(22) Filed: Apr. 26, 2021

(30) Foreign Application Priority Data
Aug. 26, 2020 (IN) 202041036850
Jan. 21, 2021 (IN) 202041036850

(51) Int. Cl. G06F 9/455; G06F 9/30; G06F 9/50

(52) U.S. Cl. CPC G06F 9/45558; G06F 2009/4557; G06F 9/5072; G06F 9/3005

(57) ABSTRACT

The present disclosure relates to data center application troubleshooting. One method includes raising a first alarm for a particular flow of a plurality of flows of an application hosted by a software-defined datacenter in response to a metric for the particular flow exceeding a configurable threshold, wherein the first alarm is raised in a displayed topology of the application, and raising a second alarm for the application in response to the first alarm.

### RELATED APPLICATIONS

Benefit is claimed under 35 U.S.C. 119(a)-(d) to Provisional Foreign Application Serial No. 202041036850 filed in India entitled “DATA CENTER APPLICATION TROUBLESHOOTING”, on Aug. 26, 2020, and Non-Provisional Foreign Application Serial No. 202041036850 filed in India entitled “DATA CENTER APPLICATION TROUBLESHOOTING”, on Jan. 21, 2021 by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

VCIs can be used to provide the enterprise's applications. Such applications may be made up of one or more services. It is desirable to maintain enterprise continuity despite potential failures of one or more services and/or applications. Application monitoring can be used to help provide enterprise continuity.

### BRIEF DESCRIPTION OF THE DRAWINGS

FIG. 1 is a diagram of a host and a system for data center application troubleshooting according to one or more embodiments of the present disclosure.

FIG. 2 is a block diagram illustrating an example application topology according to one or more embodiments of the present disclosure.

FIG. 3 illustrates a method of data center application troubleshooting according to one or more embodiments of the present disclosure.

FIG. 4A illustrates a portion of a GUI including a diagram indicating relationships between flows and a metric threshold set at a first configuration.

FIG. 4B illustrates a portion of the GUI including the diagram indicating relationships between flows and a metric threshold set at a second configuration.

FIG. 5 is a diagram of a system for data center application troubleshooting according to one or more embodiments of the present disclosure.

FIG. 6 is a diagram of a machine for data center application troubleshooting according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

An application can be made up of one or more services, which may also be referred to as microservices, which interact with each other. These services can be deployed on various VCIs that could be part of a multi-geography (e.g., hybrid cloud) setup. The compute, network, and storage infrastructure form the underlying platform on which the application is running. These services communicate with the external entity (e.g., clients, users, etc.) and with each other to provide the necessary business intelligence. Each service can be described as a server or service endpoint, which can be represented by an Internet protocol (IP) address listening on a port. This communication between one endpoint (e.g., source IP address and source port) acting as a client with another endpoint (e.g., destination IP address and destination port) using a standard transport protocol (e.g., transmission control protocol (TCP) or uniform datagram protocol (UDP)) can be described as a “5-Tuple Flow.” A 5-tuple refers to a set of five different values that comprise a Transmission Control Protocol/Internet Protocol (TCP/IP) connection. It includes a source IP address/port number, destination IP address/port number and the protocol in use. 5-tuples can be aggregated over source port to define a 4-tuple flow, which is referred to herein as a “flow.”

The performance of an application depends on the availability of the infrastructure along with the application executable instructions (“code”) itself. The problem of monitoring and troubleshooting a complex application with a mesh of interactions is non-trivial. According to at least one embodiment of the present disclosure, the application troubleshooting can include performing fault localization on a subset of the infrastructure, using statistical analysis of the flows. Some embodiments include displaying a topology of the application to provide monitoring and/or troubleshooting. The topology can include a plurality of nodes connected by a plurality of edges. In some embodiments, each of the plurality of nodes represents a respective tier of the application and each of the plurality of edges represents one or more flows between connected nodes. For instance, in some embodiments, an edge represents a single flow between connected nodes. In other embodiments, an edge represents an aggregation of flows between connected nodes. As discussed further below, issues (e.g., anomalies or potential anomalies) can be indicated in the displayed topology. As a result, embodiments herein can provide a graphical user interface (GUI) that allows users to rapidly identify, diagnose, and ultimately correct application issues.

In various embodiments, metrics of each flow can be monitored, ingested, and/or stored as time series data. Examples of such metrics include amount of data (e.g., bytes) sent by the client, amount of data sent by the server, traffic rate sent by the client, traffic rate sent by the server, TCP round trip time (“RTT”), and TCP retransmit counts (“ReTx”), TCP retransmit percents/TCP retransmit ratios (e.g., TCP retransmit packets divided by total TCP packets sent), among others. For each physical and/or virtual element, metrics can be monitored, ingested, and/or stored. Examples of such metrics include packet drops in the transmit (“Tx”) direction, packet drops in the receive (“Rx”) direction, traffic rate in the transmit direction (“Tx Rate”), and traffic rate in the receive direction (“Rx Rate”), among others.

Thresholds can be determined for each of these metrics. When a metric exceeds a threshold, an alarm can be raised as described herein. Some embodiments include a portion of the GUI configured to allow a user to modify one or more of these thresholds. For instance, some embodiments include a displayed diagram representing a plurality of flows. The diagram can indicate relationships between each the plurality flows and a threshold associated with a given metric. In an example, flows are depicted in a Sankey diagram, in which flows that do not exceed an RTT threshold are displayed in a first color (e.g., green) and flows that exceed the RTT threshold are displayed in a second color (e.g., red). A slider bar or other functionality can be provided to allow adjustment of the RTT threshold. As the threshold is adjusted, the diagram can be updated (e.g., in real time) to indicate the change in the relationships between each of the flows and the threshold.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

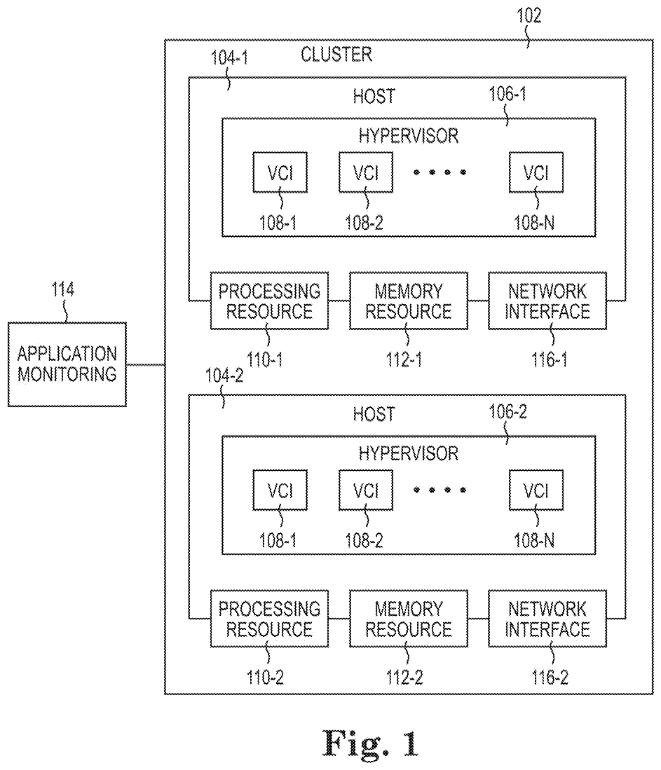

The figures herein follow a numbering convention in which the first digit or digits correspond to the drawing figure number and the remaining digits identify an element or component in the drawing. Analogous elements within a Figure may be referenced with a hyphen and extra numeral or letter. Such analogous elements may be generally referenced without the hyphen and extra numeral or letter. For example, elements 108-1, 108-2, and 108-N in FIG. 1 may be collectively referenced as 108. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for data center application troubleshooting according to one or more embodiments of the present disclosure. The system can include a cluster 102 in communication with an application troubleshooting controller 114. The cluster 102 can include a first host 104-1 with processing resources 110-1 (e.g., a number of processors), memory resources 112-1, and/or a network interface 116-1. Similarly, the cluster 102 can include a second host 104-2 with processing resources 110-2, memory resources 112-2, and/or a network interface 116-2. Though two hosts are shown in FIG. 1 for purposes of illustration, embodiments of the present disclosure are not limited to a particular number of hosts. For purposes of clarity, the first host 104-1 and/or the second host 104-2 (and/or additional hosts not illustrated in FIG. 1) may be generally referred to as “host 104.” Similarly, reference is made to “hypervisor 106,” “VCI 108,” “processing resources 110,” memory resources 112,” and “network interface 116,” and such usage is not to be taken in a limiting sense.

The host 104 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 104-1 can incorporate a hypervisor 106-1 that can execute a number of VCIs 108-1, 108-2, . . . , 108-N (referred to generally herein as “VCIs 108”). Likewise, the host 104-2 can incorporate a hypervisor 106-2 that can execute a number of VCIs 108. The hypervisor 106-1 and the hypervisor 106-2 are referred to generally herein as a hypervisor 106. The VCIs 108 can be provisioned with processing resources 110 and/or memory resources 112 and can communicate via the network interface 116. The processing resources 110 and the memory resources 112 provisioned to the VCIs 108 can be local and/or remote to the host 104. For example, in a software-defined data center, the VCIs 108 can be provisioned with resources that are generally available to the software-defined data center and not tied to any particular hardware device. By way of example, the memory resources 112 can include volatile and/or non-volatile memory available to the VCIs 108. The VCIs 108 can be moved to different hosts (not specifically illustrated), such that a different hypervisor manages (e.g., executes) the VCIs 108. The host 104 can be in communication with the application troubleshooting controller 114. In some embodiments, the application troubleshooting controller 114 can be deployed on a server, such as a web server.

The application troubleshooting controller 114 can include computing resources (e.g., processing resources and/or memory resources in the form of hardware, circuitry, and/or logic, etc.) to perform various operations to troubleshoot applications hosted in the cluster 102. Application troubleshooting is described in more detail herein. Accordingly, in some embodiments, the application troubleshooting controller 114 can be part of a cluster controller (e.g., a vSAN cluster manager). In embodiments in which the application troubleshooting controller 114 is part of a vSAN cluster controller, the local disks of the hosts 104-1 and 104-2 can act as pooled storage for the cluster 102 (e.g., a datastore) that can store data corresponding to the VCIs 108-1, . . . , 108-N.

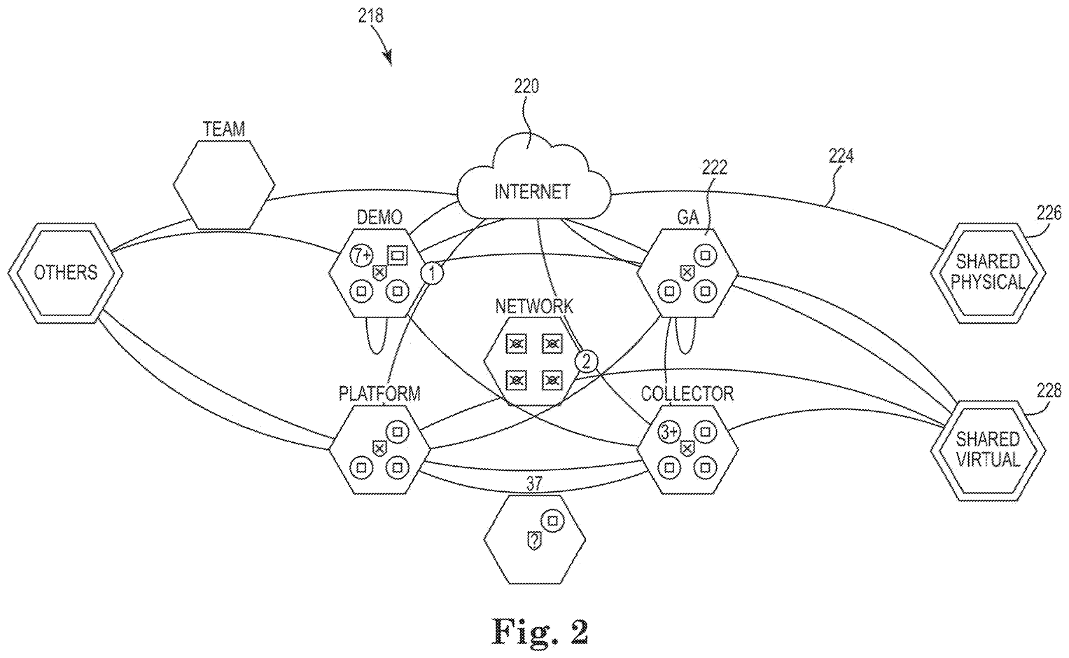

FIG. 2 is a block diagram illustrating an example application topology according to one or more embodiments of the present disclosure. The topology can be a portion of a GUI in accordance with the present disclosure. The example topology (e.g., graph) includes nodes comprised of the tiers of the application, shared services and the Internet 220. Shared services in the example illustrated in FIG. 2 include shared physical services 226 and shared virtual services 228. As shown in the example illustrated in FIG. 2, tiers of the application include “Team,” “Demo,” “Platform,” “37,” “Collector,” “Network,” and “GA” 222. It is noted that these tiers are examples and embodiments of the present disclosure are not limited to the specific example tiers shown in FIG. 2. Each tier is logically defined as a set of compute nodes that provides the same service. The edges of the graph represent aggregation of flows between the respective nodes. In some instances herein, edges may be alternately referred to as flows. It is noted that only one flow, shared physical-to-Internet flow 224 (referred to herein simply as “flow 224”) is labeled in the example illustrated in FIG. 2 so as not to obscure embodiments of the present disclosure.

A user can interact with the topology in different ways. For example, selecting a tier can cause the display of more detailed information corresponding to the selected tier. Selecting a flow can cause the display of a flow dashboard corresponding to the selected flow. A flow dashboard can display information corresponding to the selected flow(s). Such information can include, for example, flow type, service endpoints, flows for which an alarm has been raised (e.g., degraded flows), total flow traffic, etc. Selection of a flow for which an alarm has been raised can cause the display of even more detailed information, such as the time-based values of the various metrics discussed herein. As a result, users can identify an issue and drill down to finer and finer levels of detail to determine the cause of the issue.

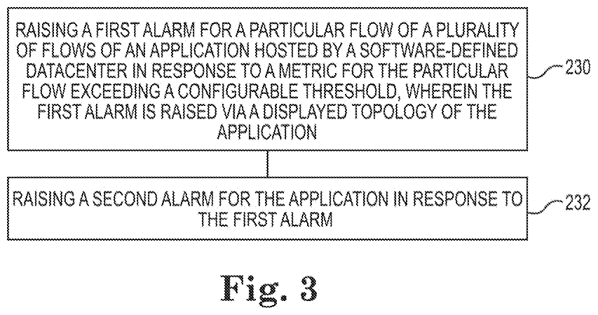

FIG. 3 illustrates a method of data center application troubleshooting according to one or more embodiments of the present disclosure. At 230, the method includes raising a first alarm for a particular flow of a plurality of flows of an application hosted by a software-defined datacenter in response to a metric for the particular flow exceeding a configurable threshold, wherein the first alarm is raised via a displayed topology of the application. The configuration and flow data of the network can be maintained to provide the path taken by each flow through the network of physical and virtual elements. As previously discussed, metrics of each flow can be monitored, ingested, and/or stored as time series data. Examples of such metrics include amount of data (e.g., bytes) sent by the client, amount of data sent by the server, traffic rate sent by the client, traffic rate sent by the server, RTT, and ReTx, among others. For each physical and/or virtual element, metrics can be monitored, ingested, and/or stored. Examples of such metrics include packet drops in the transmit direction, packet drops in the receive direction, traffic rate in the transmit direction, and traffic rate in the receive direction, among others.

At 232, the method includes raising a second alarm for the application in response to the first alarm. As known to those of skill in the art, two methods of application troubleshooting include reactive and proactive. Reactive application troubleshooting can use prior knowledge that the application has experienced an issue. The fault can be localized to the part of the infrastructure which could be responsible for the application issue based on the analysis described herein. Proactive application troubleshooting can include analysis (e.g., continuous analysis) of the flow metrics and the network infrastructure elements to raise an alarm in response to a determination that a particular application could face an issue based on the analysis described herein. In both reactive and proactive troubleshooting, the same underlying mechanism can be used to localize the application issue to a particular component, and vice versa.

Time series of metrics for flows and the network elements can be used. According to at least one embodiment of the present disclosure, a framework for the analysis described herein can include two modules. A first module can include logical and infrastructure components of the application and a second module can include statistical analysis techniques of the metrics of the components. The first module can focus on the flows of the application and the physical and virtual (logical) switches and routers that are part of the network infrastructure and that are in the path of the flows. The second module can make use of an anomaly detection technique, (e.g., Median Absolute Deviation (“MAD”)), for anomaly detection on metrics time series. An alarm can be raised if the metric's deviation exceeds a configurable threshold.

The flows of the application can be analyzed for any issue. Some embodiments include raising an alarm in response to the RTT exceeding a configurable static threshold (e.g., based on the application service level agreement (“SLA”). Some embodiments include raising an alarm in response to an anomaly in the RTT of a flow being detected. Some embodiments include raising an alarm in response to an anomaly in the ReTx of a flow being detected. For instance, some embodiments include raising an alarm in response to the ReTx exceeding a ReTx threshold and some embodiments include raising an alarm in response to a TCP retransmit ratio (e.g., percent) exceeding a TCP retransmit ratio threshold. Some embodiments include raising an alarm in response to an anomaly in the traffic pattern of a flow being detected.

If an alarm is raised for any flow of the application, that flow can be marked (e.g., as being “red”). In proactive troubleshooting, an alarm can be raised for the application based on the corresponding flow being marked. Raising the alarm can include displaying an indication of the alarm in the GUI. In some embodiments, for instance, the display color of the edge corresponding to the flow in the topology 218 of FIG. 2 can be modified. For example, if an alarm is raised for the flow between the shared physical services 226 and the internet 220, the flow 224 can be changed from a default color (e.g., white) to an alarm color (e.g., red). Such change can readily indicate the existence of the alarm, as well as valuable contextual information, to a user.

In reactive troubleshooting, for each marked flow, the path of the flow can be computed based on the network model. Anomaly detection can be computed for the metrics of each network element in the path. An alarm can be raised in response to an anomaly being detected in the packet drops on a network interface in the path. An alarm can be raised in response to an anomaly being detected in the traffic pattern on a network interface in the path.

In reactive troubleshooting, given a specified time period, in response to an anomaly being detected in one or more flows in the application, a determination can be made as to whether there is high probability that those flows (and the underlying code and/or infrastructure enabling them) caused the application issue. If within the same specified period, an anomaly is detected in any network element in the path of the affected flows, then a determination can be made that there is high probability that those network elements are responsible for the application issue. In response to no anomaly in any network element in the path of the affected flows, a determination can be made that there is high probability that the network is not the reason for the application issue. This type of determination can simplify the process of troubleshooting for users by removing potential causes from consideration. If the potential causes of the issue can be narrowed down, a solution is more easily discovered.

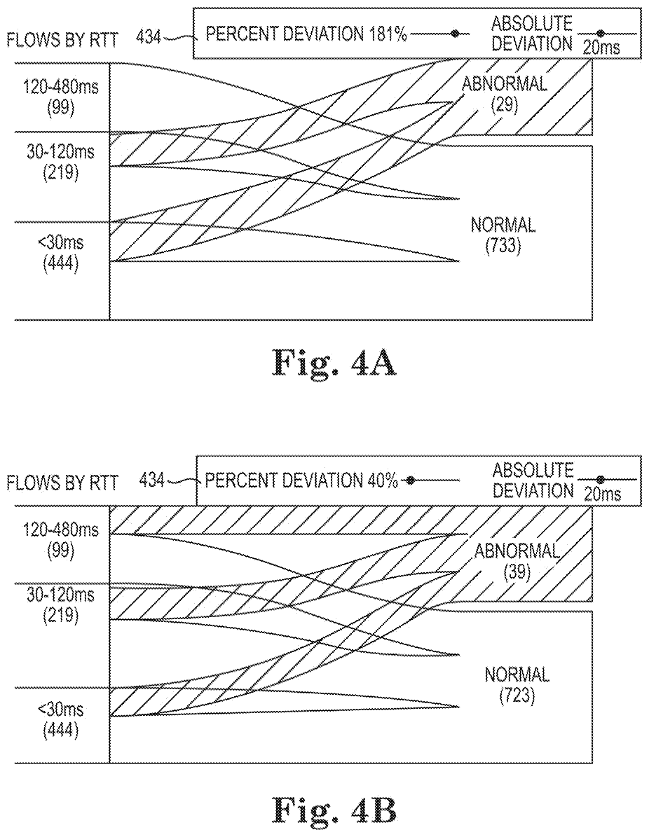

FIG. 4A illustrates a portion of a GUI including a diagram indicating relationships between flows and a metric threshold set at a first configuration. FIG. 4B illustrates a portion of the GUI including the diagram indicating relationships between flows and a metric threshold set at a second configuration.

As shown in FIG. 4A, the metric being displayed in the diagram is RTT. The flows are separated into three groups: one for RTT less than 30 milliseconds, one for RTT between 30 and 120 milliseconds, and one for RTT between 120 and 480 milliseconds. A threshold adjustment portion 434 of the GUI allows a user to adjust the RTT threshold. For instance, in FIG. 4A, the threshold is set at 181% deviation (e.g., deviation from expected RTT). A slider bar is provided to allow adjustment. In addition to the percent deviation threshold, an absolute deviation threshold can be provided, which represents an amount of deviation from the expected RTT. As shown in FIG. 4A, either threshold can be adjusted by sliding the value along a scale. As shown in FIG. 4A, 29 flows indicated as being abnormal exceed the 181% deviation threshold and 733 flows indicated as being normal do not exceed the 181% deviation threshold.

As shown in FIG. 4B, the percent deviation slider of the threshold adjustment portion has been modified such that the threshold is now set at 40% deviation. As a result, the relationship of some of the flows to the threshold has changed. As shown in FIG. 4B, 39 flows are indicated as abnormal for exceeding the updated threshold and 723 flows are indicated as normal for not exceeding the updated threshold. By providing users with easily adjustable thresholds, embodiments herein make the process of troubleshooting more intuitive and proactive. For instance, even if a threshold has not yet been met, a user can see which thresholds are being approached and where to direct troubleshooting efforts. In some instances, potential issues can be corrected before they arise, saving time and effort.

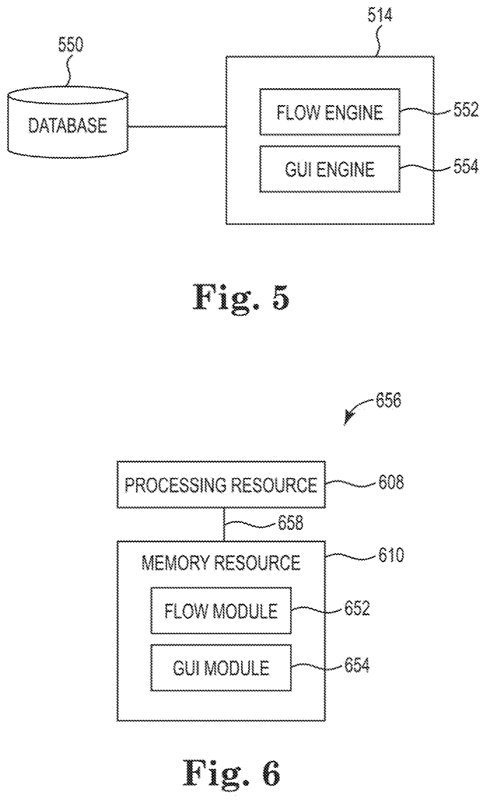

FIG. 5 is a diagram of a system 514 for data center application troubleshooting according to one or more embodiments of the present disclosure. The system 514 can include a database 550 and/or a number of engines, for example flow engine 552 and/or GUI engine 554, and can be in communication with the database 550 via a communication link. The system 514 can include additional or fewer engines than illustrated to perform the various functions described herein. The system can represent program instructions and/or hardware of a machine (e.g., machine 656 as referenced in FIG. 6, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the flow engine 552 can include a combination of hardware and program instructions that is configured to receive a plurality of metrics corresponding to each of a plurality of flows between a plurality of entities associated with an application hosted by a software-defined datacenter. In some embodiments, the GUI engine 554 can include a combination of hardware and program instructions that is configured to provide a GUI. The GUI can be configured to display a topology of the application, the topology comprising a plurality of nodes connected by a plurality of edges, wherein each of the plurality of nodes represents one of the plurality of entities, and wherein each of the plurality of edges represents a respective flow between connected entities. The GUI can be configured to indicate an alarm for a particular flow of the plurality of flows in response to a metric of the plurality of metrics exceeding a configurable threshold.

In some embodiments, the flow engine 552 is configured to receive, for each of a plurality of network elements corresponding to the application hosted by the software-defined datacenter, a quantity of packet drops in a transmit direction, a quantity of packet drops in a receive direction, a traffic rate in the transmit direction, and/or a traffic rate in the receive direction. In some embodiments, the system 514 can include a path engine configured to determine a path of the particular flow through a plurality of network infrastructure elements.

In some embodiments, the GUI engine is configured to indicate the alarm for the particular flow in response to a determined anomaly in a quantity of packet drops by any one of the plurality of network infrastructure elements. In some embodiments, the GUI engine is configured to indicate the alarm for the particular flow in response to a determined anomaly in a traffic pattern through any one of the plurality of network infrastructure elements. In some embodiments, the GUI engine is configured to display a diagram (e.g., such as that shown in FIGS. 4A and/or 4B) representing a plurality of flows, wherein the diagram indicates relationships between each the plurality of flows and a threshold associated with a particular metric of the plurality of metrics.

FIG. 6 is a diagram of a machine for data center application troubleshooting according to one or more embodiments of the present disclosure. The machine 656 can utilize software, hardware, firmware, and/or logic to perform a number of functions. The machine 656 can be a combination of hardware and program instructions configured to perform a number of functions (e.g., actions). The hardware, for example, can include a number of processing resources 608 and a number of memory resources 610, such as a machine-readable medium (MRM) or other memory resources 610. The memory resources 610 can be internal and/or external to the machine 656 (e.g., the machine 656 can include internal memory resources and have access to external memory resources). In some embodiments, the machine 656 can be a VCI. The program instructions (e.g., machine-readable instructions (MRI)) can include instructions stored on the MRM to implement a particular function (e.g., an action such as receiving a plurality of metrics, as described herein). The set of MRI can be executable by one or more of the processing resources 608. The memory resources 610 can be coupled to the machine 656 in a wired and/or wireless manner. For example, the memory resources 610 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 610 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 608 can be coupled to the memory resources 610 via a communication path 658. The communication path 658 can be local or remote to the machine 656. Examples of a local communication path 658 can include an electronic bus internal to a machine, where the memory resources 610 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 658 can be such that the memory resources 610 are remote from the processing resources 608, such as in a network connection between the memory resources 610 and the processing resources 608. That is, the communication path 658 can be a network connection. Examples of such a network connection can include a local area network (LAN), wide area network (WAN), personal area network (PAN), and the Internet, among others.

As shown in FIG. 6, the MRI stored in the memory resources 610 can be segmented into a number of modules 652, 654 that when executed by the processing resources 608 can perform a number of functions. As used herein a module includes a set of instructions included to perform a particular task or action. The number of modules 652, 654 can be sub-modules of other modules. For example, the GUI module 654 can be a sub-module of the flow module 652 and/or can be contained within a single module. Furthermore, the number of modules 652, 654 can comprise individual modules separate and distinct from one another. Examples are not limited to the specific modules 652, 654 illustrated in FIG. 6.

Each of the number of modules 652, 654 can include program instructions and/or a combination of hardware and program instructions that, when executed by a processing resource 608, can function as a corresponding engine as described with respect to FIG. 5. For example, the flow module 652 can include program instructions and/or a combination of hardware and program instructions that, when executed by a processing resource 608, can function as the flow engine 552, though embodiments of the present disclosure are not so limited.

The machine 656 can include a flow module 652, which can include instructions to receive a plurality of metrics corresponding to each of a plurality of flows between a plurality of entities associated with an application hosted by a software-defined datacenter. The machine 656 can include a GUI module 654, which can include instructions to provide a graphical user interface (GUI) configured to display a topology of the application, the topology comprising a plurality of nodes connected by a plurality of edges, wherein each of the plurality of nodes represents one of the plurality of entities, and wherein each of the plurality of edges represents a respective flow between connected entities. The GUI module 654 can include instructions to provide a graphical user interface (GUI) configured to indicate an alarm for a particular flow of the plurality of flows in response to a metric of the plurality of metrics exceeding a configurable threshold.

In some embodiments, the machine 656 includes instructions to indicate an alarm for a flow in response to a threshold deviation of the traffic rate of bytes sent by the client from an expected traffic rate of bytes sent by the client. In some embodiments, the machine 656 includes instructions to indicate an alarm for a flow in response to a threshold deviation of the traffic rate of bytes sent by the server from an expected traffic rate of bytes sent by the server. In some embodiments, the machine 656 includes instructions to indicate an alarm for a flow in response to the transmission control protocol round trip time exceeding a round trip time threshold. In some embodiments, the machine 656 includes instructions to indicate an alarm for a flow in response to a threshold deviation of the transmission control protocol round trip time from an expected transmission control protocol round trip time. In some embodiments, the machine 656 includes instructions to indicate an alarm for a flow in response to a threshold deviation of the transmission control protocol retransmit count from an expected transmission control protocol retransmit count.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
raising a first alarm for a particular flow of a plurality of flows of an application hosted by a software-defined datacenter in response to a metric for the particular flow exceeding a configurable threshold, wherein the first alarm is raised via a displayed topology of the application; and
raising a second alarm for the application in response to the first alarm.

2. The method of claim 1, wherein the metric is a Transmission Control Protocol (TCP) round trip time (RTT) corresponding to the particular flow, and wherein raising the first alarm comprises raising the first alarm in response to the TCP RTT corresponding to the particular flow exceeding an RTT threshold.

3. The method of claim 1, wherein the metric is a Transmission Control Protocol (TCP) round trip time (RTT) corresponding to the particular flow, and wherein raising the first alarm comprises raising the first alarm in response to a threshold deviation of the TCP RTT from an expected TCP RTT.

4. The method of claim 1, wherein the metric is a Transmission Control Protocol (TCP) retransmit count corresponding to the particular flow, and wherein raising the first alarm comprises raising the first alarm in response to:
a threshold deviation of the TCP retransmit count from an expected TCP retransmit count; or
the TCP retransmit count exceeding a TCP retransmit count threshold.

5. The method of claim 1, wherein the metric is a traffic rate corresponding to the particular flow, and wherein raising the first alarm comprises raising the first alarm in response to a threshold deviation of the traffic rate from an expected traffic rate.

6. The method of claim 1, wherein the method includes displaying the topology of the application, the topology comprising a plurality of nodes connected by a plurality of edges, wherein each of the plurality of nodes represents a respective tier of the application, and wherein each of the plurality of edges represents a plurality of flows between connected nodes.

7. The method of claim 6, wherein the method includes visually indicating the first alarm and the second alarm in the displayed topology of the application.

8. A non-transitory machine-readable medium having instructions stored thereon which, when executed by a processor, cause the processor to:
receive a plurality of metrics corresponding to each of a plurality of flows between a plurality of entities associated with an application hosted by a software-defined datacenter;
provide a graphical user interface (GUI) configured to:
display a topology of the application, the topology comprising a plurality of nodes connected by a plurality of edges, wherein each of the plurality of nodes represents one of the plurality of entities, and wherein each of the plurality of edges represents at least one flow between connected entities; and
indicate an alarm for a particular flow of the plurality of flows in response to a metric of the plurality of metrics exceeding a configurable threshold.

9. The medium of claim 8, wherein the plurality of entities include a plurality of tiers of the application, a plurality of shared services used by the application, and the Internet.

10. The medium of claim 8, wherein the instructions include instructions to receive, for each of the plurality of flows:
a quantity of bytes sent by a client;
a quantity of bytes sent by a server;
a traffic rate of bytes sent by the client;
a traffic rate of bytes sent by the server;
a transmission control protocol round trip time; and
a transmission control protocol retransmit count.

11. The medium of claim 10, including instructions to indicate the alarm for the particular flow in response to any one of:
a threshold deviation of the traffic rate of bytes sent by the client from an expected traffic rate of bytes sent by the client;
a threshold deviation of the traffic rate of bytes sent by the server from an expected traffic rate of bytes sent by the server;
the transmission control protocol round trip time exceeding a round trip time threshold;
a threshold deviation of the transmission control protocol round trip time from an expected transmission control protocol round trip time;
the transmission control protocol retransmit count exceeding a transmission control protocol retransmit count threshold; and
a threshold deviation of the transmission control protocol retransmit count from an expected transmission control protocol retransmit count.

12. The medium of claim 11, including instructions to visually indicate, via the GUI, the alarm for the particular flow of the application in the displayed topology of the application by changing a color of one of the plurality of edges that corresponds to the particular flow.

13. The medium of claim 12, wherein the GUI is configured to display a flow dashboard responsive to a selection of the particular flow in the displayed topology, wherein the flow dashboard displays information corresponding to the particular flow.

14. A system, comprising:
a flow engine configured to receive a plurality of metrics corresponding to each of a plurality of flows between a plurality of entities associated with an application hosted by a software-defined datacenter; and
a GUI engine configured to provide a graphical user interface (GUI) configured to:
display a topology of the application, the topology comprising a plurality of nodes connected by a plurality of edges, wherein each of the plurality of nodes represents one of the plurality of entities, and wherein each of the plurality of edges represents a respective flow between connected entities; and
indicate an alarm for a particular flow of the plurality of flows in response to a metric of the plurality of metrics exceeding a configurable threshold.

15. The system of claim 14, wherein the flow engine is configured to receive, for each of a plurality of network elements corresponding to the application hosted by the software-defined datacenter:
a quantity of packet drops in a transmit direction;
a quantity of packet drops in a receive direction;
a traffic rate in the transmit direction; and
a traffic rate in the receive direction, and
wherein the GUI engine is configured to display a respective configurable threshold associated with each of: the quantity of packet drops in the transmit direction, the quantity of packet drops in the receive direction, the traffic rate in the transmit direction, and the traffic rate in the receive direction.

16. The system of claim 14, including a path engine configured to determine a path of the particular flow through a plurality of network infrastructure elements, and wherein the GUI engine is configured to display a representation of the determined path.

17. The system of claim 16, wherein the GUI engine is configured to indicate the alarm for the particular flow in response to any one of:
a determined anomaly in a quantity of packet drops by any one of the plurality of network infrastructure elements; and
a determined anomaly in a traffic pattern through any one of the plurality of network infrastructure elements.

18. The system of claim 14, wherein the GUI engine is configured to display a diagram representing a plurality of flows, wherein the diagram indicates relationships between each the plurality of flows and a threshold associated with a particular metric of the plurality of metrics.

19. The system of claim 18, wherein the diagram includes a portion configured to allow modification of the threshold.

20. The system of claim 19, wherein the GUI engine is configured to update the diagram, such that the diagram indicates modified relationships between the plurality of flows and the threshold, responsive to a modification of the threshold.
